(19) United States
(12) Patent Application Publication
(10) Pub. No.: US 2015/0101834 A1
(43) Pub. Date: Apr. 16, 2015

(54) Harrow Module for Vertical Tillage Apparatus

(71) Applicant: Kelley Manufacturing Company, Tifton, GA (US)

(72) Inventor: Raymond Way, Wray, GA (US)

(73) Assignee: Kelley Manufacturing Company

(21) Appl. No.: 14/513,206

(22) Filed: Oct. 13, 2014

Related U.S. Application Data
(60) Provisional application No. 61/890,566, filed on Oct. 14, 2013.

(51) Int. Cl. A01B 23/00; A01B 29/04; A01B 21/04; A01B 49/02

(52) U.S. Cl. CPC A01B 23/00; A01B 49/027; A01B 29/048; A01B 21/04
USPC 172/146; 172/544; 172/150; 172/184

(57) ABSTRACT

An apparatus for soil preparation where residual crop matter is present in the field comprising a machine having a set of discs followed by a plurality of harrow modules, the harrow module utilizing a plurality of groups of tines arranged on a longitudinal axis for rotation around the center of a shaft designed for ground working and a spring in the center of the longitudinal shaft is designed to keep constant tension on the tines for minimal wear while biased toward the soil by a pivot mechanism is designed to reduce bounce.

### FIELD OF INVENTION

The present invention relates to an Agricultural Machine. This is a machine that falls into the classification of Vertical Tillage. It is designed for shallow tillage with minimal soil compaction. The present invention relates to soil tillage and more particularly relates to a machine to be used to reduce the residue from previous crops in a field either prior to spring or fall land operations. In even greater particularity components of the machine relate to utilization of a unique tine mounting system for a harrow module.

### BACKGROUND

The machine is excellent in running in high residue conditions to prepare a field for planting where there is too much residue for a field cultivator. Using the machine, residue is left on top of soil for better decomposition. Disk harrows, which have been commonly used, bury much of the residue and thus slow down decomposition. Leaving residue on the soil surface helps to reduce wind and water soil erosion which is especially helpful in areas where soil conservation is important.

The current machine is excellent for residue management in the fall after harvest when farmers can use this machine to incorporate a cover crop and also in spring when they can use the machine for field preparation. The present invention is an improvement over the utilization of the harrow tines presented in U.S. Pat. No. 5,000,270 to Phillips and U.S. Pat. No. 7,325,623 to Hake et al. This machine is more aggressive than the Phillips Harrow and can run in heavier residue or grassy conditions.

### SUMMARY OF THE INVENTION

A general object of the invention is reduce the work load in preparing a field for replanting by controlling the utilization of the residue from the previous growth cycle. Discs on the front of the machine move some residue and soil away from the center of the machine and the mounting of the harrow modules allows for small amounts of residue and soil to be moved back towards the center. This allows for some leveling to take place, such as covering ruts, etc. These modules do a superior job of mixing crop seed (cover crop) and chemicals in heavy residue and in finished soil. The harrow tooling does not create soil compaction as disc harrows do. The harrow tooling brings residue to the surface for better decomposition. This is also advantageous in areas where soil conservation is important because having residue on the surface helps to reduce wind and water soil erosion.

### BRIEF DESCRIPTION OF THE DRAWINGS

Referring to the drawings which are appended hereto and which form a portion of this disclosure, it may be seen that:

FIG. 1 is a perspective view of the overall tillage machine;

FIG. 2 is a top plan view of the tillage machine;

FIG. 3 is a elevation view of the harrow module;

FIG. 4 is a detail exploded view of the harrow module components.

FIG. 5 is a sectional view of the spring end of the harrow module.

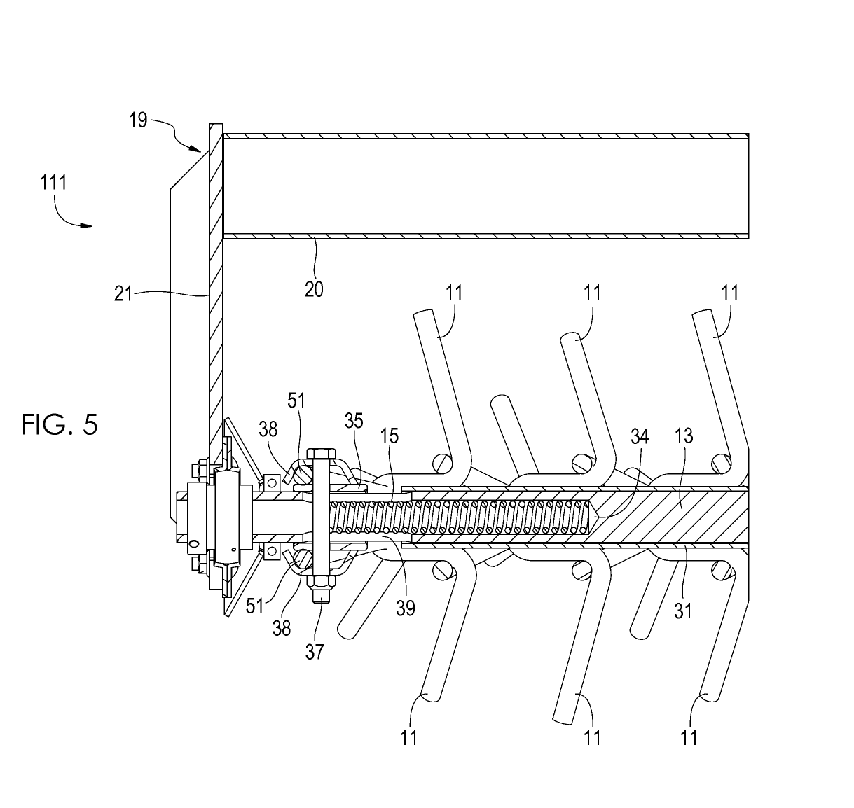

FIG. 6 is a sectional view of the opposite end of the harrow module.

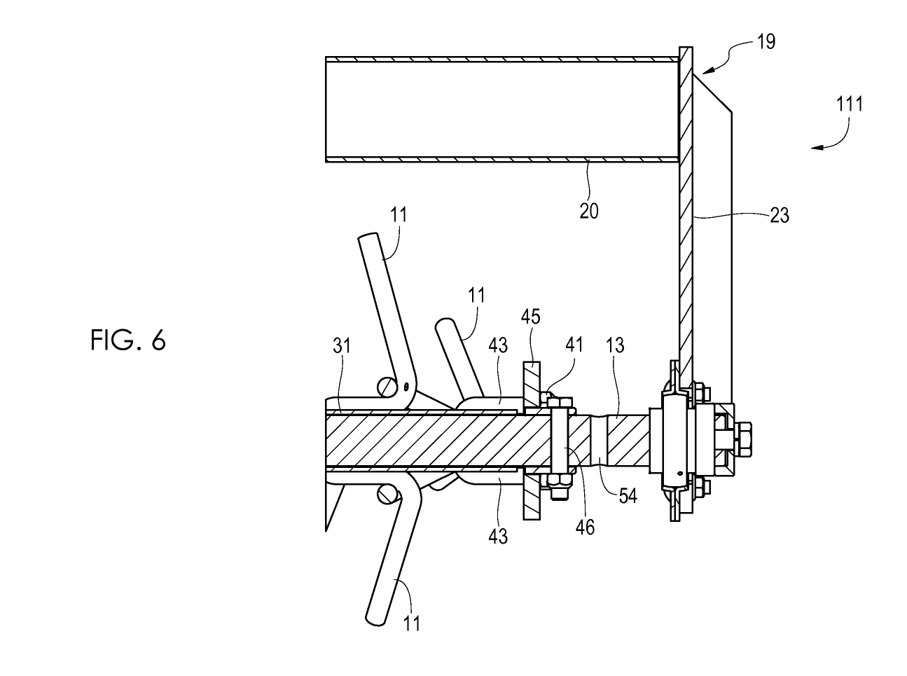

### DETAILED DESCRIPTION

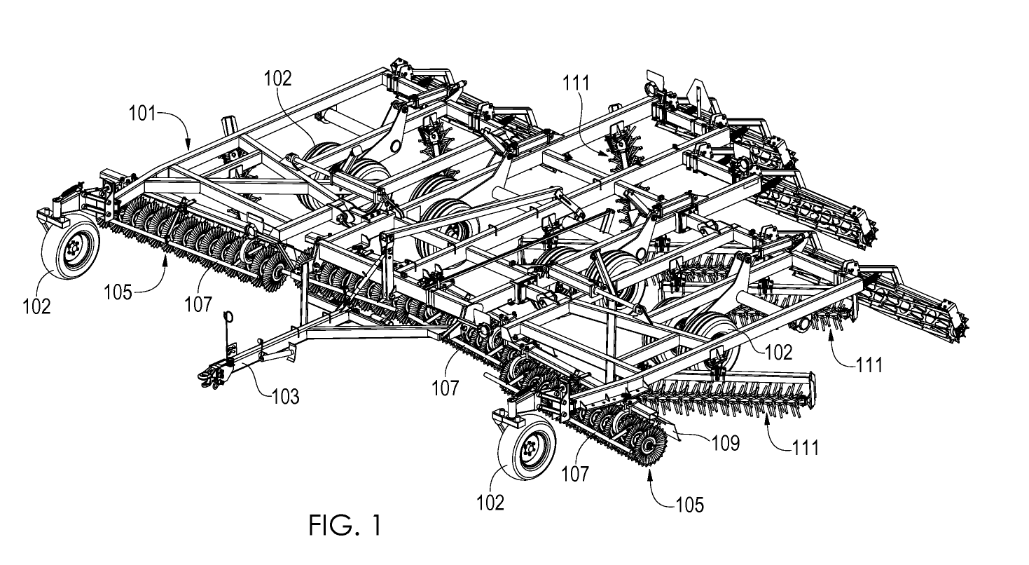

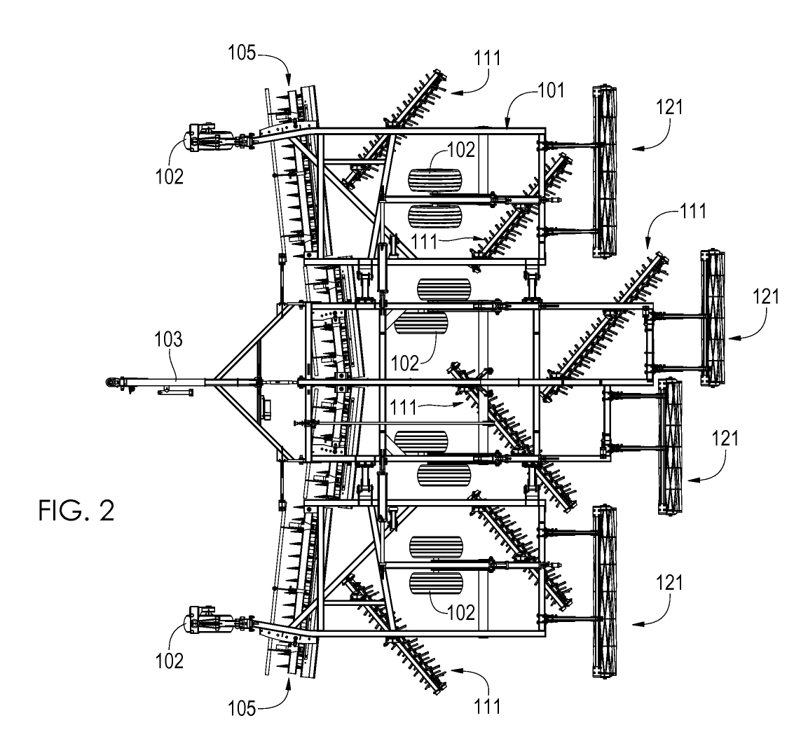

Referring to FIGS. 1 and 2 for an overall view of the machine in which the harrow module is used, note that the machine is intended for tractor drawn usage and comprises a generally open frame assembly 101 mounted on ground engaging tires 102 and adapted for connection to the tractor or other prime mover, not shown, by tongue 103. Disc gangs 105 are affixed to the frame 101 in a forward position. Knock down bars 107 in front of disc gangs 105 lay over standing residue (corn stalks, wheat, rye, etc) so that the disc gangs 105 can cut and size the residue. Disc gangs 105 are adjustable for varying degrees of aggressiveness. They can be adjusted at to the following angles 6°, 10°, 14°, 18°. The shallower angles are preferred if the soil conditions are soft enough to allow the trailing Harrow Modules 111 to penetrate. In harder soils a more aggressive (larger) disc angle will tear up and shatter most soils to allow the Harrow Modules 111 to be more effective. The Soil Razor™ discs stay sharp throughout the life of the disc. A soil deflector shield 109 is mounted behind the disc gangs 105 and helps to prevent horizontal movement of soil and residue and helps reduce ridging on sides of machine.

Each Harrow Module 111 includes a ground working tool composed of a plurality of groups of tines 11 arranged on a longitudinal axis for rotation around the center of a shaft 13. These tines are similar to the tines disclosed in U.S. Pat. No. 5,000,270. Each ground working tool comprises a plurality of tool elements 51 arranged in a series of groups 53, there being two tool elements in each group in this embodiment. Each group of tool elements inter-engages with the next adjacent group to form flexible connections between the groups that will permit tensioning of the tool in the longitudinal direction when supported for rotation by the shaft 13 and module frame 19.

Each tool element 51 comprises a loop portion 55 and a pair of fingers 11. When the groups of tool elements are inter-engaged and the tool longitudinally tensioned, the fingers 11 define tines which are spaced about and project outwardly with respect to the longitudinal axis of the tool.

The loop portion 55 of each tool element is substantially U-shaped having two spaced arms 59 and a base 61 which bridges the arms. The tines 11 extend one from the free end of each arm 59 of the loop portion. The two arms 59 of each loop portion occupy a common plane and the tines 11 deviate from that plane to one side thereof.

As mentioned hereinbefore, the tool elements are connected together in a series of groups, with each group having two tool elements. In this way, each group provides four projecting tines. The loop portion 55 of each tool element 51 receives one pair of fingers from a neighboring tool group, with the fingers being held captive between the arms of the loop and the base. The arrangement is such that the inner ends of the fingers are received in the loop portion, the fingers being inserted into the loop portion through the open end of the U.

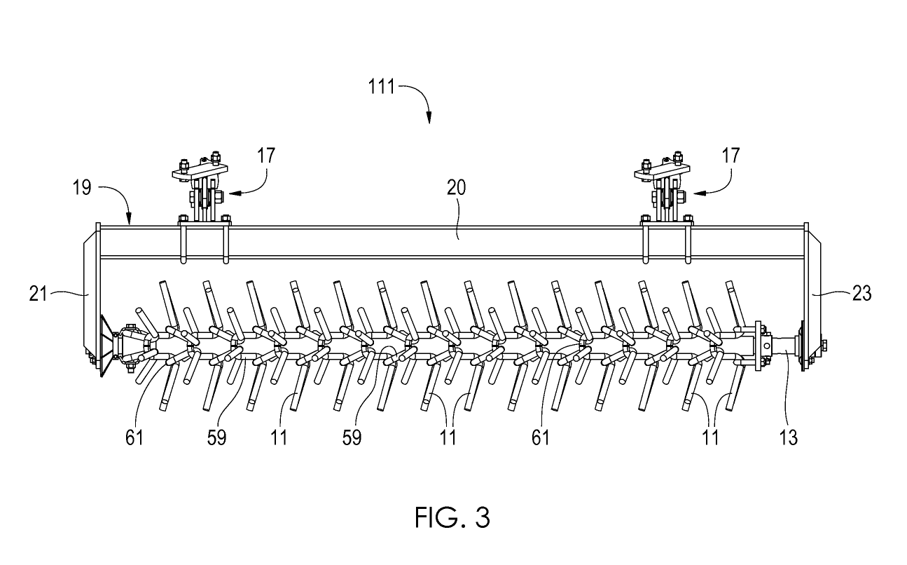

A spring 15 in the center of the longitudinal shaft 13 is designed to keep constant tension on the elements for minimal wear. The pivot mechanism 17 on the module frame 19 is designed to reduce bounce. Additional features of harrow module are shown in FIGS. 3 and 7 to 9. Module frame 19 is a rectangular tube 20 with welded side plates 21, 23 to support the bearings 25. These side plates 21, 23 are ribbed to prevent deflection and bending. Center shaft 13 is a solid shaft that keeps even pressure on the tines 11 as they engage with the ground. Shaft stop 29 is an additional mechanism to help prevent shaft slippage in a longitudinal direction. This is in addition to the locking collars 27 already on the bearings. Module cushion hose 31 is a thin wall rubber hose that slides over the length of the shaft 13. This fills in the gap between the center shaft 13 and the tool elements 51, prevents looseness and thus helps to prevent wear on the connecting parts of the tooling. It also acts as a cushion for the tines and helps to take any shock loading. Bearing shield 33 on trailing edge of harrow module 11 helps protect the bearing and helps prevent fine threadlike components of residue from working under the triple lip seals of the bearings.

Spring tension on harrow tooling is the most distinctive feature of this assembly. An axial bore 34 is drilled in one end of the solid shaft 13.

Lateral slots 39 are formed in the shaft 13 along the bore 34 and a slider tube 35 is movably mounted onto the shaft 13 overlying the slots 39. A compression spring 15 is seated within the bore 34. Slider tube 35 carries a bolt 37 which passes through lateral slots 39 and bore 34 at the end of the spring 15 such that the bolt can be urged against the spring. Captured on the bolt, externally of the slider tube 35, are a pair of clips 38 that secure the loops 55 of two terminal tool elements 51 in the harrow tooling. On the other end of the shaft 13, a module tension weldment 45 is affixed to the shaft by a bolt 46 passing through one of two transverse apertures 54 in shaft 13. Locknuts 41 are tightened on U-bolts 43 which pass through the weldment and engage the opposite terminal tool elements and urge the tool elements into tension, thereby compressing the spring 15 within axial bore 34. The spring 15 bearing against bolt 37 keeps constant tension on the harrow tooling and thus helps reduce wear significantly on the interconnecting elements 51. Tension weldment (45) allows for extra tightening of the harrow tooling if wear occurs to the point that the spring 15 no longer puts tension on the elements 51 by securing module tension weldment (45) using the next transverse aperture 54 in the shaft 13. This will re-tension the spring.

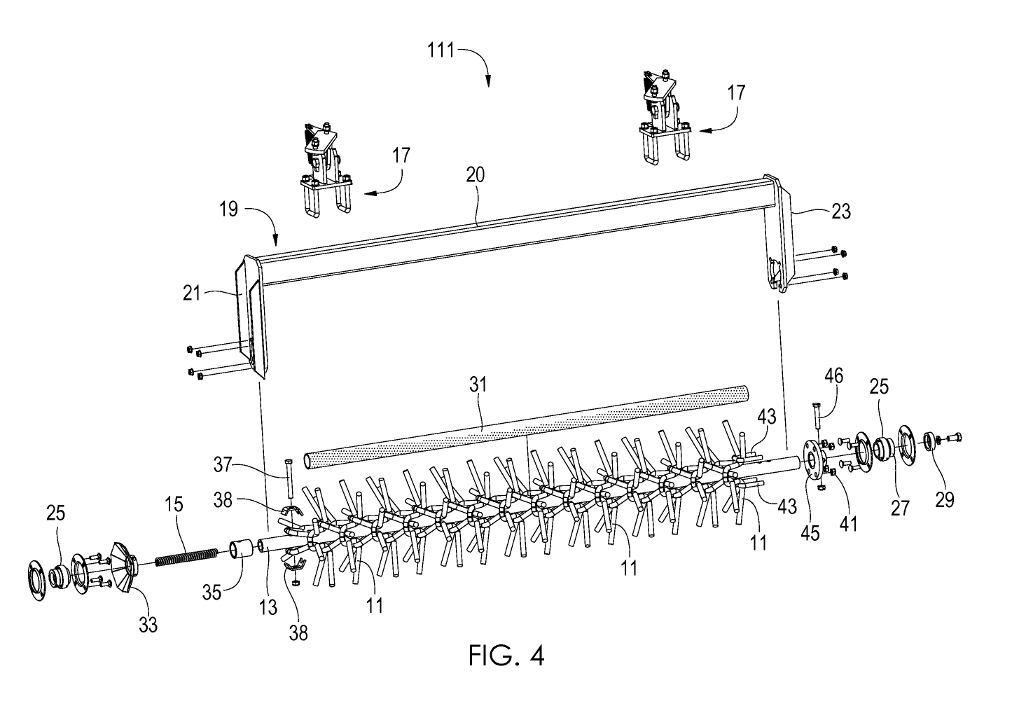

As may be seen, in FIG. 4 the harrow module assembly is preferably mounted onto pivot brackets 17 attached to main frame 101. These pivot brackets have springs 18 that keep constant down pressure on the Harrow Module as it runs in the field. Harrow modules are attached to the Resi-Till Machine frame at a 40° (50° from a line in the direction of travel) angle. This has proved to be an optimal running angle although other angles may prove suitable. Harrow modules are mounted opposed to each other from the center line of the machine, as shown in FIGS. 1 and 2. It should be noted that the harrow modules may be mounted to the frame in a fixed rather than pivotable manner such that the springs 18 are eliminated.

The harrow tines on the Harrow Module do a superb job of bringing residue to the surface or tearing up weeds and grass. They are also excellent in leveling and incorporating seed and/or chemicals. They are designed to pivot and float over obstacles and terrain but use spring down pressure to prevent bounce. The solid shaft in the center of the tines keeps pressure on entire length of module for increased aggressiveness. The extra weight of solid shaft also helps with aggressiveness. Rolling baskets 121 on the rear of frame 101 help to lay over any standing residue, help to pin residue into soil, help to break up clods and mix soil.

While in the foregoing specification this invention has been described in “relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

What we claim is:

1. A harrow module for use in a soil tillage apparatus, comprising: a plurality of groups of tines arranged on a longitudinal axis for rotation around the center of a shaft designed for ground working; a spring in the center of the longitudinal shaft connected to said tines to keep constant tension on the tines.

2. A harrow module as defined in claim 1 wherein said groups of tines comprise interlinked tines surrounding said shaft with each group of times interlaced with axially spaced groups of tines.

3. A harrow module as defined in claim 2 wherein said spring is connected to an end group of tines of said plurality of tines at one end of said shaft and the opposite end of said shaft is connected to a group of tines at the opposite end of said plurality of groups of tines such that said spring is held in compression by said tines and said shaft.

4. A harrow module as defined in claim 3 wherein said spring is confined within a longitudinal bore in said one end of said shaft and is connected to said end group of tines by a member passing transversely of said bore and through opposing slots opening into said bore.

5. A harrow module as defined in claim 1 wherein said shaft is supported at each end for rotation on a frame.

6. A harrow module as defined in claim 5 wherein said spring is confined within a longitudinal bore in said one end of said shaft and is connected to an end group of tines by a member passing transversely of said bore and through opposing slots opening into said bore.

7. A harrow module as defined in claim 6 wherein said spring is connected to an end group of tines of said plurality of tines at one end of said shaft and the opposite end of said shaft is connected to a group of tines at the opposite end of said plurality of groups of tines such that said spring is held in compression by said tines and said shaft.

8. A harrow module as defined in claim 7 wherein said groups of tines comprise interlinked tines surrounding said shaft with each group of times interlaced with axially spaced groups of tines.

9. A harrow module as defined in claim 5 wherein said frame is pivotally mounted to an associated frame to allow said frame to pivot about a generally horizontal axis.

10. A harrow module as defined in claim 1 wherein a cushioning sleeve is surrounds said shaft between said shaft and said plurality of tines.

11. A soil tillage apparatus comprising: a frame adapted for connection to a prime mover; a plurality of harrow modules, adapted for ground working and including a plurality of groups of tines arranged on a longitudinal axis for rotation around the center of a shaft said shaft including a spring in the center thereof and adapted to keep constant tension on the tines for minimal wear.

12. A soil tillage apparatus as defined in claim 11 wherein said spring is confined within a longitudinal bore in said one end of said shaft and is connected to an end group of tines by a member passing transversely of said bore and through opposing slots opening into said bore.

13. A soil tillage apparatus comprising as defined in claim 11 further comprising a pivot mechanism connecting the harrow modules to the frame at a preselected angle biasing said harrow modules toward the soil relative to the frame; and a smoother selected from a reel smoother or a roll smoother affixed to said frame and trailing behind said harrow modules.

14. A soil tillage apparatus as defined in claim 11 wherein said spring is connected to an end group of tines of said plurality of tines at one end of said shaft and the opposite end of said shaft is connected to a group of tines at the opposite end of said plurality of groups of tines such that said spring is held in compression by said tines and said shaft.

15. A soil tillage apparatus as defined in claim 14 further comprising a plurality of disc gangs attached to the frame proximal the prime mover: a plurality of knock down bars, extending generally parallel to and mounted forwardly of said disc gangs.

16. A soil tillage apparatus as defined in claim 15 further comprising a smoother selected from a reel smoother or a roll smoother affixed to said frame and trailing behind said harrow modules.

17. A soil tillage apparatus comprising: a frame adapted for connection to a prime mover; a plurality of disc gangs attached to the frame proximal the prime mover: a plurality of knock down bars, extending generally parallel to and mounted forwardly of said disc gangs; a plurality of harrow modules, adapted for ground working and including a plurality of groups of tines arranged on a longitudinal axis for rotation around the center of a shaft said shaft including a spring in the center thereof and adapted to keep constant tension on the tines for minimal wear; and a pivot mechanism connecting the harrow modules to the frame at a preselected angle biasing said harrow modules toward the soil relative to the frame; and a smoother selected from a reel smoother or a roll smoother affixed to said frame and trailing behind said harrow modules.
